(19) United States
(12) Patent Application Publication
(10) Pub. No.: US 2004/0256833 A1
(43) Pub. Date: Dec. 23, 2004

(54) Step assembly for a vehicle

(76) Inventor: Dean A. Cervenka, Lafayette, IN (US)

Correspondence Address: TREXLER, BUSHNELL, GIANGIORGI,, BLACKSTONE & MARR, LTD., 105 WEST ADAMS STREET, SUITE 3600, CHICAGO, IL, 60603, US

(21) Appl. No.: 10/820,678

(22) Filed: Apr. 8, 2004

Related U.S. Application Data
(60) Provisional application No. 60/479,049, filed on Jun. 17, 2003.

(51) Int. Cl. B60R 3/00

(52) U.S. Cl. 280/163

(57) ABSTRACT

A step assembly generally includes a step and a mounting member for attaching the step to a trailer hitch mounted to a vehicle. The step is pivotally attached to the mounting member and rotates relative to the mounting member from a generally horizontal position to a generally vertical position. The step includes a stepping member upon which a user steps to gain access to the cargo area of a vehicle. When the step is in the generally vertical position, the stepping member is positioned higher than the bumper of the vehicle.

### RELATED APPLICATION

This application claims the benefit of U.S. provisional patent application Ser. No. 60/479,049 filed on Jun. 17, 2003.

### BACKGROUND OF THE INVENTION

Certain vehicles, such as pick-up trucks and sport utility vehicles (SUV) include cargo areas which are difficult for a user to access because of the height of the cargo area from the ground. In the past, different types of steps have been utilized to assist a user in accessing the cargo areas of such vehicles. A number of these steps are mounted to the vehicle through the use of the vehicle's trailer hitch receiver. As the trailer hitch receiver is in use in this type of step, mounting of the step to the vehicle prevents the user from towing a trailer using the trailer hitch receiver when the step is connected to the vehicle.

Other steps mounted to the vehicle are pivotally connected to the vehicle allowing the step to move from a horizontal position in use, to a vertical position when the step is not in use. When using these types of steps with pick-up trucks, for example, when the tail gate of the pick up-truck is lowered, the step is positioned under the tail gate of the pick-up truck and provides no assistance to the user.

A disadvantage of providing a step at the rear of the vehicle is that the step extends rearwardly of the vehicle creating an obstruction. As a result, additional space is needed to park the vehicle; one must take care when passing behind the rear of the vehicle to avoid the step; and when traveling on a road, other vehicles must avoid the rearwardly extending step which can often be difficult to see.

The present invention provides a step assembly which eliminates or reduces the problems described and provides additional advantages as will be described herein.

### OBJECTS AND SUMMARY OF THE INVENTION

A general object of the present invention is to provide a step assembly for allowing easier access to the cargo area of a vehicle.

An object of the present invention is to provide a step assembly which provides easier access to the cargo area of a pick-up truck when the gate of the pick-up truck is in a lowered position.

Another object of the present invention is to provide a step assembly which allows for use of a trailer hitch assembly when the step assembly is mounted to the vehicle.

Yet another object of the present invention is to provide lighting to the area around the step assembly when the step assembly is in a generally horizontal or vertical position.

A further object of the present invention is to provide an additional brake light for the vehicle to which the step assembly is mounted.

Yet a further object of the present invention is to provide protection for the tailgate or rear of the vehicle from impact.

Still a further object of the present invention is to provide security to the tailgate or rear of the vehicle.

A still further object of the present invention is to provide a power supply to which electronic accessories can be attached.

Briefly, an in accordance with the forgoing, the present invention discloses a folding step assembly which can be mounted to a standard trailer hitch receiver. The step assembly is particularly useful when mounted to pick-up truck or a sport utility vehicle in that it allows for easier access to the bed of the pick-up truck or the cargo area of the SUV which are typically approximately thirty-three (33) inches above ground level. The height of the step assembly when in the lowered position is approximately one-half of the distance between the ground and the bed of the pick-up truck or SUV.

### BRIEF DESCRIPTION OF THE DRAWINGS

FIG. 1 is a perspective view of a step assembly mounted to a vehicle which incorporates features of first embodiment of the invention, such step assembly shown in its lowered position;

FIG. 2 is a perspective view of the step assembly of FIG. 1, such step assembly shown in its raised position;

FIG. 3 is an exploded perspective view of the step assembly of FIG. 1 and a portion of a trailer hitch receiver;

FIG. 4 is a perspective view of the step assembly of FIG. 1, such step assembly shown in its raised position;

FIG. 4a is a detailed perspective view of a portion of the step assembly shown in FIG. 4;

FIG. 5 is a perspective view of the step assembly of FIG. 1 mounted to a vehicle, such step assembly shown in a raised position;

FIG. 5a is an enlarged view of a portion of FIG. 5;

FIG. 6 is a cross-sectional view of the step assembly shown in FIG. 1 mounted to a vehicle and taken along line XX of FIGURE X, such step assembly shown in a raised position;

FIG. 6a is an enlarged view of a portion of FIG. 6;

FIG. 7 is a cross-sectional view of the step assembly mounted to a vehicle and taken along line 7-7 of FIG. 5a, such step assembly shown in a lowered position, and such step assembly shown in phantom line in a raised position;

FIG. 7a is an enlarged view of a portion of FIG. 7;

FIG. 8 is a top plan view of the step assembly of FIG. 1 mounted to a vehicle, such step assembly shown in a lowered position and the tail gate of the vehicle shown in a lowered position;

FIG. 9 is a perspective view of a step assembly mounted to a vehicle which incorporates the features of a second embodiment of the invention, such step assembly shown in its raised position;

FIG. 10 is an exploded perspective view of the step assembly of FIG. 9 and a portion of a trailer hitch receiver;

FIG. 11 is a perspective view of the step assembly of FIG. 9, such step assembly shown in its raised position;

FIG. 12 is a rear elevational view of the step assembly of FIG. 9, such step assembly shown in its raised position;

FIG. 13 is a perspective view of the step assembly of FIG. 9, such step assembly shown in its lowered position;

FIG. 14 is a perspective view of the step assembly of FIG. 9, such step assembly shown in its lowered position;

FIG. 15 is a partially exploded perspective view of a step assembly which incorporates the features of a third embodiment of the invention, such step assembly shown in its lowered position;

FIG. 16 is a perspective view of the step assembly of FIG. 15 mounted to a vehicle, such step assembly shown in its raised position; and

FIG. 17 is a perspective view of a step assembly which incorporates the features of a fourth embodiment of the invention.

### DETAILED DESCRIPTION OF THE INVENTION

While the invention may be susceptible to embodiment in different forms, there is shown in the drawings, and herein will be described in detail, specific embodiments with the understanding that the present disclosure is to be considered an exemplification of the principles of the invention, and is not intended to limit the invention to that as illustrated and described herein.

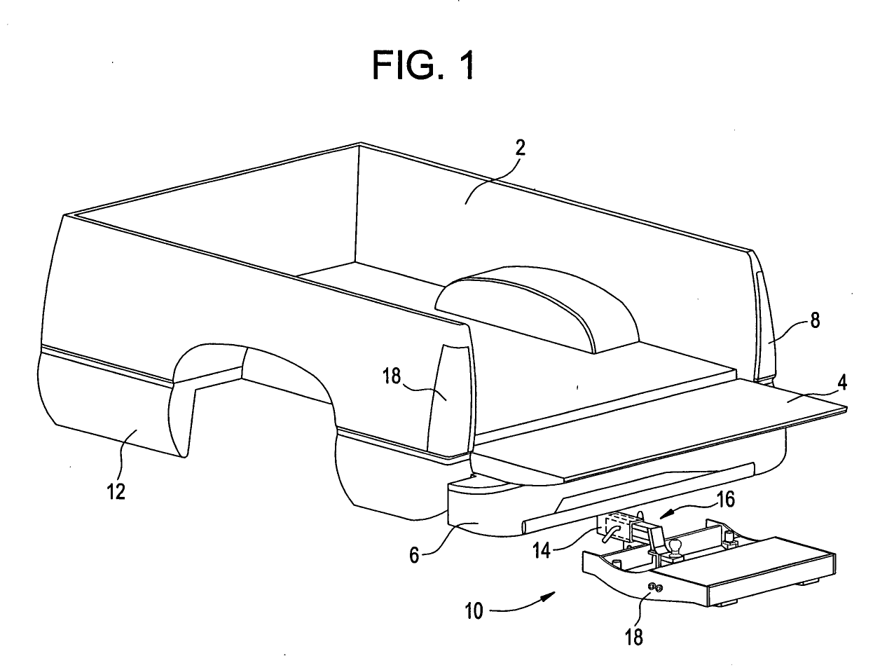

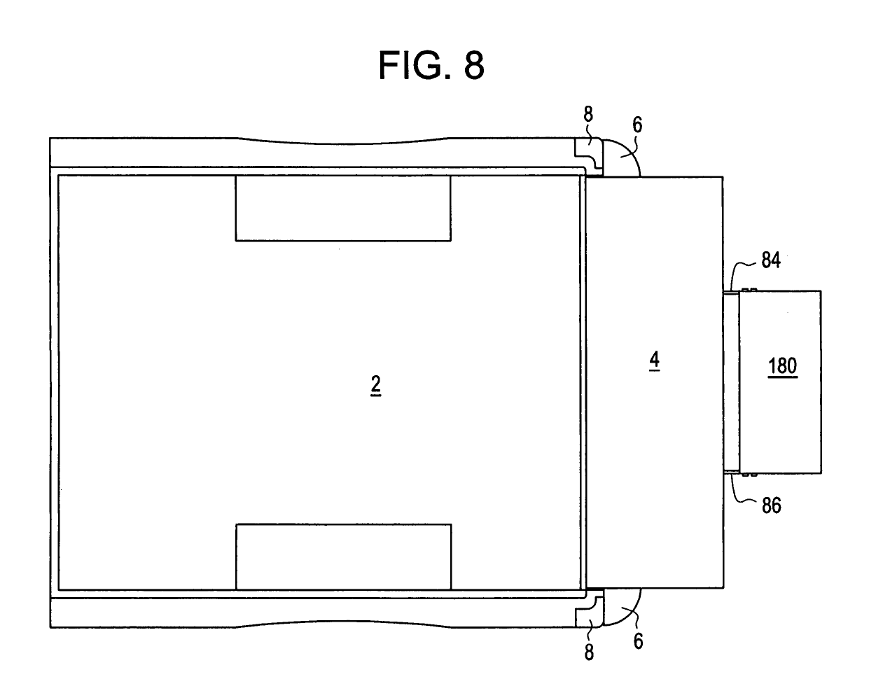

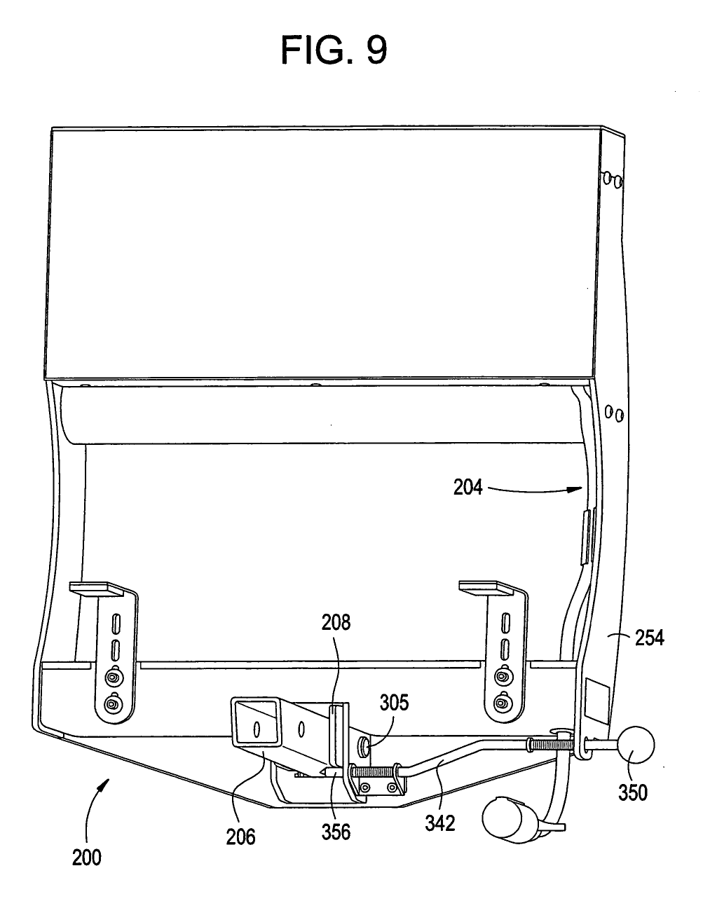

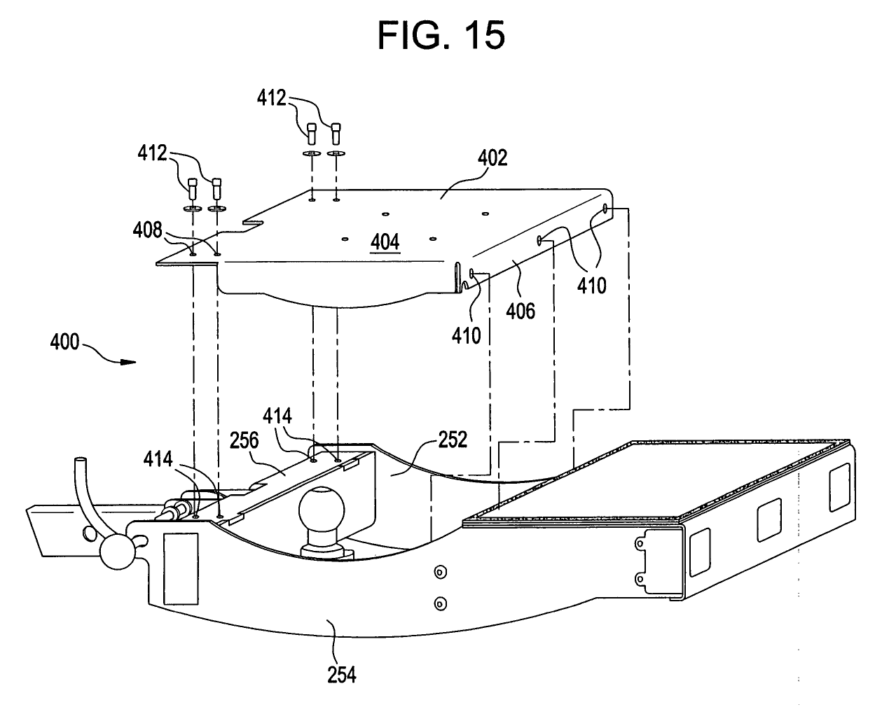

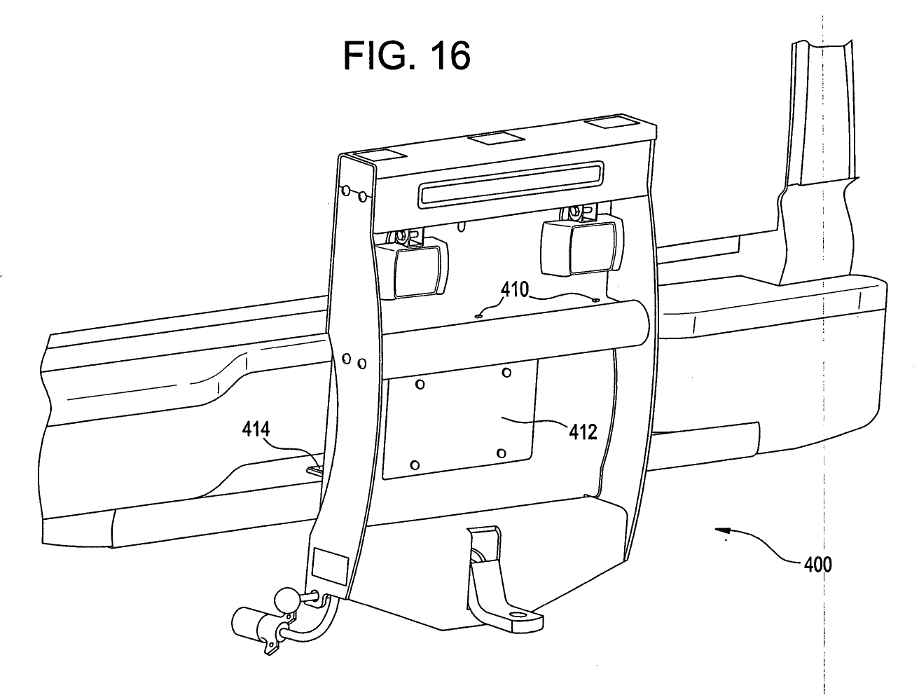

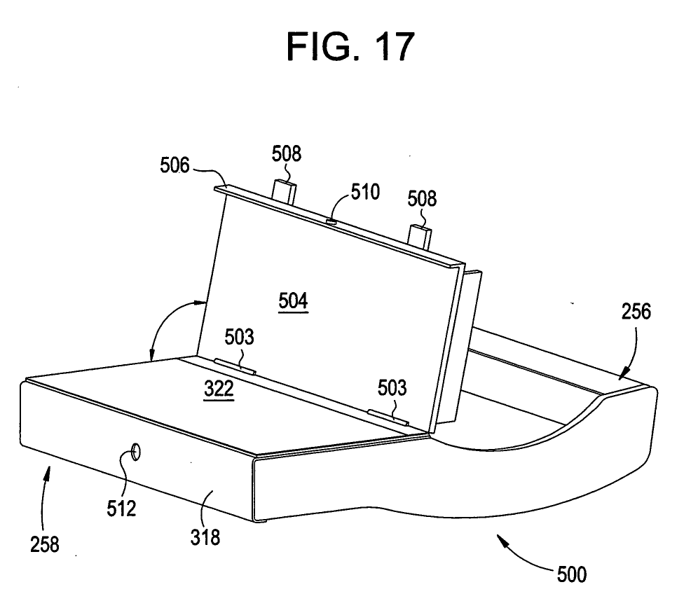

A first embodiment of the invention is shown in FIGS. 1-8, a second embodiment of the invention is shown in FIGS. 9-14, a third embodiment of the invention is shown in FIG. 15-16; and a fourth embodiment of the invention is shown in FIG. 17.

Attention is now invited to the first embodiment of the invention shown in FIGS. 1-8. As shown in FIG. 1, a step assembly 10 is mounted to the rear of a vehicle 12, for example, a pick-up truck or a sports utility vehicle. The vehicle 12 includes a bed or cargo area 2, a tailgate 4, a bumper 6 and tail or brake lights 8. The step assembly 10 is mounted to the vehicle 12 using the conventional trailer hitch receiver 14. A conventional trailer hitch receiver 14 is mounted to the frame of the vehicle 12 in a conventional manner and extends underneath the vehicle 12. For the purposes of this description, the following definitions shall apply: front or forward shall refer to elements or portions of elements closest to the front of the vehicle 12 or in the direction of the front of the vehicle 12; rear or rearward shall refer to elements or portions of elements closest to the rear of the vehicle 12; left side shall refer to elements or portions of elements closest to the driver's side of the vehicle 12; and right side shall refer to elements or portions of elements closest to the passenger's side of the vehicle 12.

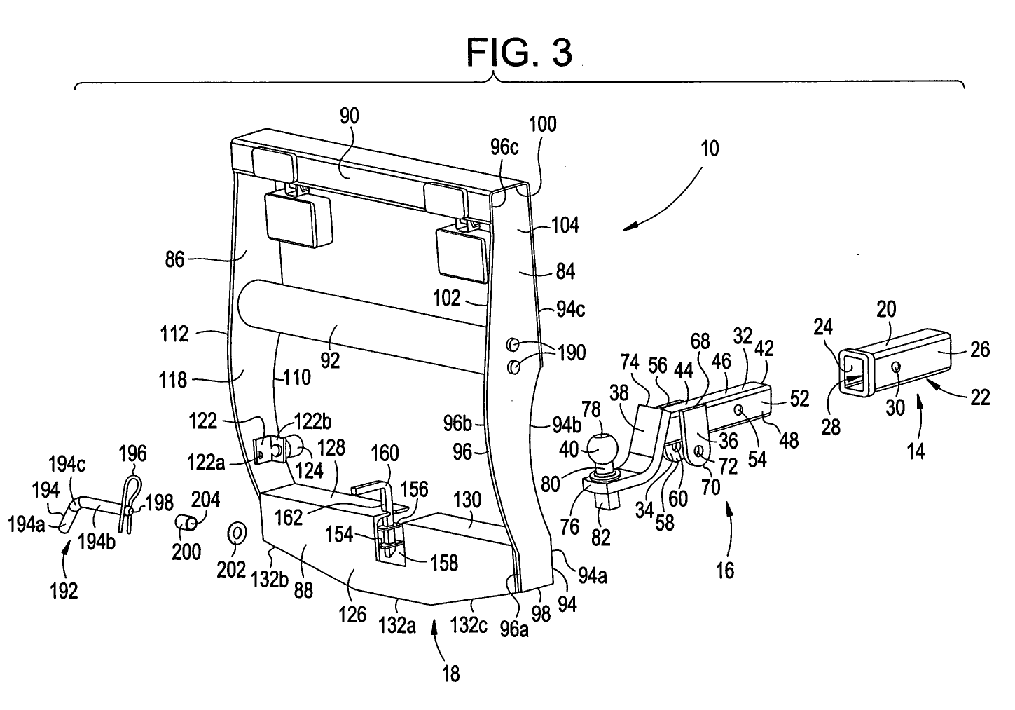

As best shown in FIG. 3, the trailer hitch receiver 14 is generally tubular and has a rectangular cross-section. The trailer hitch receiver 14 includes an upper wall 20, a lower wall 22, a left wall 24 and a right wall 26. A receiver passageway 28 is defined by inner surfaces of the walls 20, 22, 24, 26. Pin apertures 30 are provided through the left wall 24 and the right wall 26 for receiving a retaining pin as will be described herein.

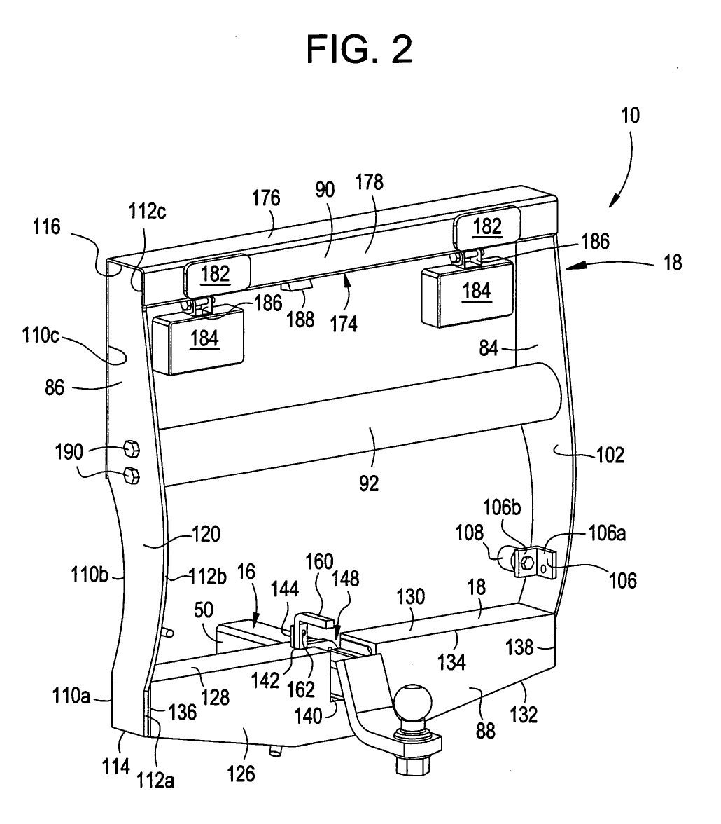

As shown in FIGS. 2-4, the step assembly 10 generally includes a mounting member 16 which is slidably engaged with the trailer hitch receiver 14, and a step 18 which is pivotally mounted to the mounting member 16. The mounting member 16 includes a shaft 32, a left side plate 34, a right side plate 36, a brace 38, and a ball assembly 40.

The shaft 32 is generally tubularly-shaped, has a rectangular cross section, and has a front end 42 and a rear end 44. The shaft 32 includes a top wall 46, a bottom wall 48, a left wall 50 (see FIG. 2) and a right wall 52. The height of the shaft 32 is slightly smaller than the height of the receiver passageway 28 and the width of the shaft 32 is slightly smaller than the width of the receiver passageway 28 such that the shaft 32 may be positioned within the receiver passageway 28. Aligned pin apertures 54 are provided through the left and right walls 48, 50.

The left side plate 34 includes a top end 56 and a bottom end 58. The bottom end 58 of the left side plate 34 is semi-circularly shaped. The left side plate 34 is mounted to the left wall 50 of the shaft 32, proximate the rear end 44 of the shaft 32.

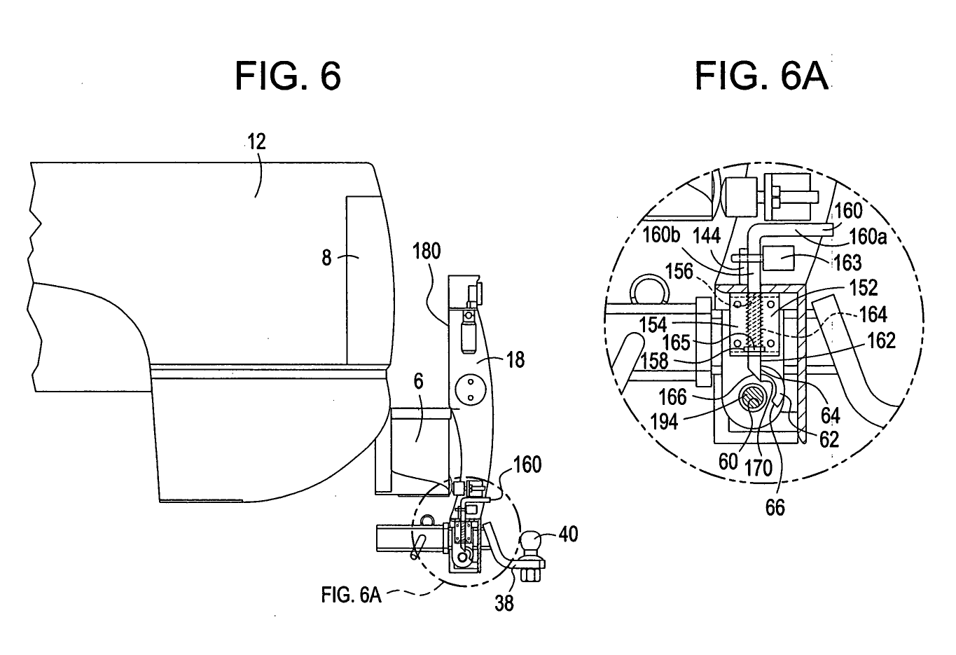

The bottom end 58 of the left side plate 34 extends below the bottom wall 48 of the shaft 32. A pivot pin aperture 60 is provided through the left side plate 34 proximate the bottom end 58 thereof. A crescent-shaped flange 62 (see FIG. 6a) is provided on the external side of the left side plate 34 and is spaced from the aperture 60. The flange includes a first end 64 and a second end 66.

The right side plate 36 includes a top end 68 and a bottom end 70. The bottom end 70 of the right side plate 36 is semi-circularly shaped. The right side plate 36 is mounted to the right wall 52 of the shaft 32, proximate the rear end 44 of the shaft 32. The bottom end 70 of the right side plate 36 extends below the bottom wall 48 of the shaft 32. A pivot pin aperture 72 is provided through the right side plate 36 proximate the bottom end 70 thereof. The pivot pin apertures 60, 72 are aligned with each other.

The brace 38 includes a front end 74 and a rear end 76. The front end 74 of the brace 38 is fixed to the rear end 44 of the shaft 32. The brace 38 extends rearwardly and downwardly from the rear end 44 of the shaft 32. A ball aperture is provided proximate the rear end 76 of the brace 38.

The ball assembly 40 is conventional and includes a head 78, a pin 80 extending downwardly from the head 78, and a nut 82 threadedly engaged with the pin 80. The pin 80 is positioned through the ball aperture of the brace 38. The nut 82 is provided on the end of the pin 80 proximate the lower side of the brace 38.

The step 18 is generally rectangularly-shaped and generally includes a right support 84, a left support 86, a front member 88, a rear member 90, and a cross tube 92. The step 18 can be made from a variety of materials, such as, for example, tubular stainless steel, tubular painted steel, steel plate or plastic materials.

The right support 84 is elongated and includes a top edge 94, a bottom edge 96, a front edge 98, a rear edge 100, an interior side 102 and an exterior side 104. The top edge 94 includes a first portion 94a, a second portion 94b and a third portion 94c. The first portion 94a extends from the front edge 98; the second portion 94b is curved and extends from the first portion 94a to the third portion 94c; and the third portion 94c extends from the second portion 94b to the rear edge 100. The bottom edge 96 includes a first portion 96a, a second portion 96b, and a third portion 96c. The first portion 96a extends from the front edge 98 of the right support 84 and is parallel to the first portion 94a of the top edge 94; the second portion 96b is curved and extends from the first portion 96a to the third portion 96c; and the third portion 96c extends from the second portion 96b to the rear edge 100 of the right support 84 and is parallel to the third portion 94c of the top edge 94. Mounting apertures are provided through the right support 84.

An L-shaped mounting bracket 106 (see FIG. 2) is provided on the interior side 102 of the right support 84. The mounting bracket 106 includes a first portion 106a fixed to the interior side 102 of the right support 84 and a second portion 106b extending perpendicularly from the interior side 102 of the right support 84. An aperture is provided through the second portion 106b. An anti-rack bumper 108 is mounted within the aperture and extends beyond the top edge 94 of the right support 84 proximate the second portion 94b of the top edge 94. The anti-rack bumper 108 is preferably made of rubber and its use is described herein.

The left support 86 is elongated and includes a top edge 110, a bottom edge 112, a front edge 114 (see FIG. 2), a rear edge 116, an interior side 118 and an exterior side 120. The top edge 110 includes a first portion 110a, a second portion 110b and a third portion 110c. The first portion 110a extends from the front edge 114; the second portion 110b is curved and extends from the first portion 110a to the third portion 110c. The third portion 110c extends from the second portion 110b to the rear edge 116. The bottom edge 112 includes a first portion 112a, a second portion 112b, and a third portion 112c. The first portion 112a extends from the front edge 114 of the left support 86 and is parallel to the first portion 110a of the top edge 110; the second portion 112b is curved and extends from the first portion 112a to the third portion 112c; and the third portion 112c extends from the second portion 112b to the rear edge 116 of the right support 86 and is parallel to the third portion 110c of the top edge 110. Mounting apertures are provided through the left support 86.

An L-shaped mounting bracket 122 (see FIG. 3) is provided on the interior side 118 of the left support 86. The mounting bracket 122 includes a first portion 122a fixed to the interior side 118 of the left support 86 and a second portion 122b extending perpendicularly from the interior side 118 of the left support 86. An aperture is provided through the second portion 122b. An anti-rack bumper 124 is mounted within the aperture and extends beyond the top edge 110 of the left support 86 proximate the second portion 110b of the top edge 110. The anti-rack bumper 124 is preferably made of rubber and its use is described herein.

The front member 88 includes a first panel 126, a second panel 128 and a third panel 130. The front member 88 extends between the left support 86 and the right support 84 proximate the front edges 114, 98 thereof.

The first panel 126 is elongated and includes a front edge 132, a rear edge 134, a left edge 136 and a right edge 138. A rectangularly-shaped notch 140 extends from the rear edge 134 of the first panel 126 a pre-determined distance. The front edge 132 includes a first portion 132a, a second portion l32b, and a third portion 132c. The first portion 132a of the front edge 132 is generally parallel to the rear edge 134 and is generally located opposite the notch 140; the second portion 132b of the front edge 132 extends from the first portion 132a to the left edge 136 and is generally angled relative to the first portion 132a; and the third portion 132c of the front edge 132 extends from the first portion 132a to the right edge 138 and is generally angled relative to the first portion 132a. The left edge 136 is generally perpendicular to the front edge 134 and abuts the interior side of the left support 86. The rear edge 134 is generally perpendicular to the front edge 134 and abuts the interior side 188 of the left support 86.

The second panel 128 is rectangularly-shaped and extends from the left support 86 to the notch 140 of the first panel 126. The second panel 128 is perpendicular to the first panel 126. A latch aperture 142 is provided through the second panel 128 proximate to the notch 140 of the first panel 126.

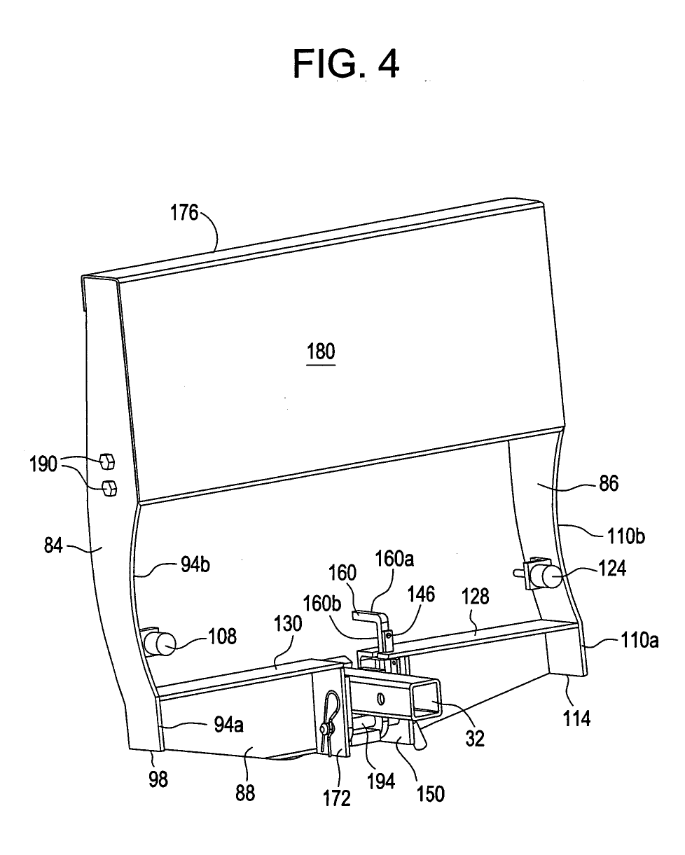

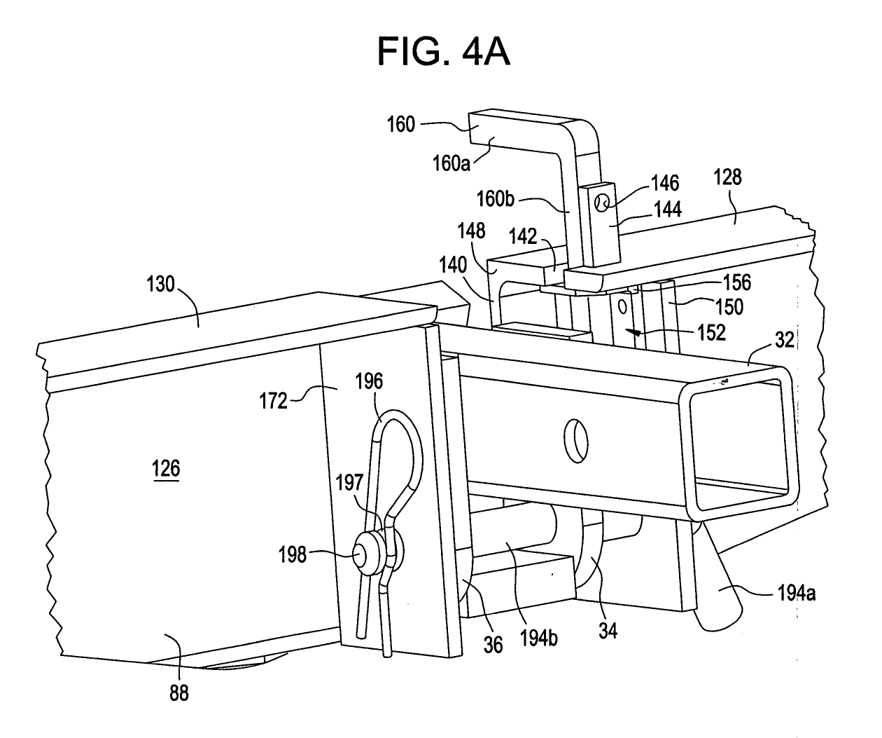

A generally rectangularly-shaped latch guide 144 extends perpendicularly from the second panel 128 and is proximate to the latch aperture 142. A lock aperture 146 (see FIGS. 4 and 4a) is provided through the free end of the latch guide 144. The third panel 130 of the front member 88 is rectangularly-shaped and extends from the right support 84 to the notch 140 of the first panel 126. The third panel 130 is perpendicular to the first panel 126 and parallel to the second panel 128. Accordingly, a notch 148 is provided between the first and second panels 124, 130 which aligns with the notch 140 and is a continuation of the notch 140.

As shown in FIGS. 4 and 4a, the front member 88 also includes a left end wall 150 provided proximate the latch aperture 142 and spaced from the notch 140, 148. The left end wall 150 abuts the first and second panels 126, 128 of the front member 88. A latch support 152 is fixed to the left end wall 150, see FIGS. 4a and 6a. The latch support 152 includes a mounting panel 154, a first extension 156 and a second extension 158. The first and second extensions 156, 158 extend generally perpendicularly from the mounting panel 154. The first extension 156 is positioned proximate the second panel 128 and the second extension 158 is spaced from the first extension 126. Apertures are provided through the first and second extensions 156, 158.

A latch 160 is mounted through the latch aperture 142 provided through the second panel 128 and through the apertures of the first and second extensions 156, 158 of the latch support 152. The latch 160 is generally L-shaped and includes a first portion 160a and a second portion 160b which is generally perpendicular to the first portion 160a. A lock aperture 162, see FIG. 2 is provided through the second portion 160b. The second portion 160b is mounted through the latch aperture 142 provided through the second panel 128 and through the apertures of the first and second extensions 156, 158 of the latch support 152 A spring 164, see FIG. 6a, is provided around a section of the second portion 160b of the latch 160 and extends between the first and second extension 156, 158 of the latch support 152. A spring abutment 165 is attached to the second portion 160b to compress the spring 164 as will be described herein. The free end of the second portion 160b of the latch 160 includes a beveled surface 166, a flat surface 168 and a tip 170. A lock 163, see FIG. 6a, may be provided through the aperture 162 of the latch 160 and through the aperture 146 of the latch guide 144 to secure the step in the upright position.

The front member 88 further includes a right end wall 172, see FIGS. 4 and 4a, provided proximate the notch 140, 148. The right end wall 172 abuts the first and third panels 126, 130 of the front member 88. An aperture is provided through the right end wall 172 and is aligned with the aperture through the left end wall 150.

As shown in FIG. 3, the rear member 90 extends from the left support 86 to the right support 84, proximate the rear edges 116, 100 thereof. The rear member 90 includes a front panel 174, a rear panel 176, a bottom panel 178 and a top panel 180. The front panel 174 is rectangularly-shaped and is spaced from the rear edges 116, 100 of the left support 86 and the right support 84. The bottom panel 178 is rectangularly-shaped and extends from the left support 86 to the right support 84 proximate the bottom edges 112, 96 thereof and from the front panel 74 to the rear panel 176. The bottom panel 178 is perpendicular to the front and rear panels 174, 176. The rear panel 176 is rectangularly-shaped and extends from the left support 86 to the right support 84 proximate the rear edges 116, 100 thereof and extends from the bottom panel 178 to the top panel 180. The rear panel 176 is perpendicular to the bottom panel 178. The top panel 180 is generally rectangular and extends from the left support 86 to the right support 84 and forward from the rear panel 176 along the third portions 110c, 94c of the top edges 110, 94 fo the left and right supports 86, 94. A tread is provided on the upper surface of the top panel 180 to provide a skid resistant surface. The tread or skid resistant surface can be created, for example, by pouched metal, raised diamond plate, bonded rubber treads, spray-on material or other skid resistant surfaces.

As shown in FIG. 2, brake lights 182 are mounted to the bottom panel 178 of the rear member 90. The brake lights 182 are spaced apart from each other such that each is proximate an end of bottom panel 178. The brake lights 182 are connected to electronic circuitry such that when the brake lights 8 (see FIG. 1) of the vehicle 12 are illuminated, the brake lights 182 are also illuminated.

Step lights 184 are mounted through swivel bases 186 to the front panel 174 of the rear member 90. The step lights 184 are spaced apart from each other such that each is proximate an end of bottom panel 178. The step lights 184 are electrically connected to a connector which is typically used to provide electrical power to a trailer, for example. The step lights 184 can be electrically connected to operate in conjunction with the vehicle's reverse lights. A switch 188 (see FIG. 2) can also be provided for to supply power to the lights upon activation of the switch 188 when the step 18 is in use. The switch 188 can be, for example, a three way switch. In a first/off position no power is supplied to the lights 184, in a second/intermediate position the lights 184 operate in connection with the reverse lights of the vehicle to indicate that the vehicle is backing up. In a third/on position the lights 184 remain illuminated.

The cross tube 92 is cylindrically-shaped and extends from the left support 86 to the right support 84. The cross tube 92 is spaced from the rear edges 116, 110 of the left support 86 and the right support 84 and is fixed to the left and right supports 86, 84, for example, by passing fasteners, such as, for example, bolts 190 through the apertures in the left and right supports 86, 84 and securing the bolts 190 to the cross tube 92. The cross tube 92 could also be welded to the left support 86 and the right support 84.

As shown in FIG. 3, a pin assembly 192 generally includes a pin 194, a bent locking wire 196, a spacer 200 and a washer 202. The pin 194 is generally elongated and includes a first portion 194a, second portion 194b, an elbow 194c, a groove 197 (see FIG. 4a) and a tip 198. The first portion 194a is angled relative to the second portion 194b, and the elbow 194c is provided between the first portion 194a and the second portion 194b. The tip 198 is provided at the end of the second portion 194b opposite the elbow 194c. The groove 197 is spaced from the tip 198. The spacer 200 is generally cylindrically-shaped and a passageway 204 is provided through the spacer 200.

Now that the specifics of the components of the step assembly 10 have been described, assembly of the step assembly 10 is described. Assembly of the step assembly 10 begins by placing the shaft 32 of the mounting member 16 into the passageway 28 of the trailer hitch receiver 14 and aligning the apertures 54 of the shaft 32 with the apertures 30 of the trailer hitch receiver 14. A pin is passed through the apertures 54, 30 to secure the shaft 32 within the trailer hitch receiver 14. Next, the step 18 is aligned with the mounting member 16 such that the shaft 32 is positioned within the notch 140, 148 of the front member 88 of the step 18. The aperture 60 through the left side plate 34 of the mounting member 16 is aligned with the aperture through the left end wall 150 of the front member 88 of the step 18, and the aperture 72 through the right side plate 36 of the mounting member 16 is aligned with the aperture through the right end wall 176 of the front member 88 of the step 18.

The tip 198 and groove 197 of the pin 194 are then passed through the aperture through the left end wall 150, through the passageway 204 of the spacer 200, through the washer 202, through the aperture in the left side plate 34, under the shaft 32 of the mounting member 16, through the aperture 72 in the right side plate 36, and through the aperture through the right end wall 172. The locking wire 196 is then placed in the groove 197 to secure the step 18 to the mounting member 16. After assembly of the step 18 with the mounting member 16, the electrical connections are made between the wiring provided on the vehicle 12 and the brake lights 182 and step lights 184 of the step 18.

As shown in FIG. 6a, when the step 18 is assembled with the mounting member 16, the first end 64 of the flange 62 abuts the flat surface 168 of the free end of the second portion 160b of the latch 160, such that the step 18 is in an upright or vertical position and to prevent the step 18 from being rotated to the lowered or horizontal position. With the step 18 in the upright position, the top panel 180 of the rear member 90 is positioned higher than and above (i.e. over) the bumper 6 of the vehicle 12 and the bumper 6 is positioned within the curvature of the second portions 110b, 94b of the top edges 110, 94 of the left and right supports 110, 94. The curvature of the second portions 10b, 94b allows the top panel 180 to be positioned closer to the tailgate 4 of the vehicle 12 by utilizing the space above the bumper 6 of the vehicle 12 when the step 18 is in the upright position. The anti-racking bumpers 108, 124 contact the bumper 6 of the vehicle and are slightly compressed. The anti-racking bumpers 108, 124 serve to dampen road vibrations and to remove any play between the step assembly 10 and the vehicle 12.

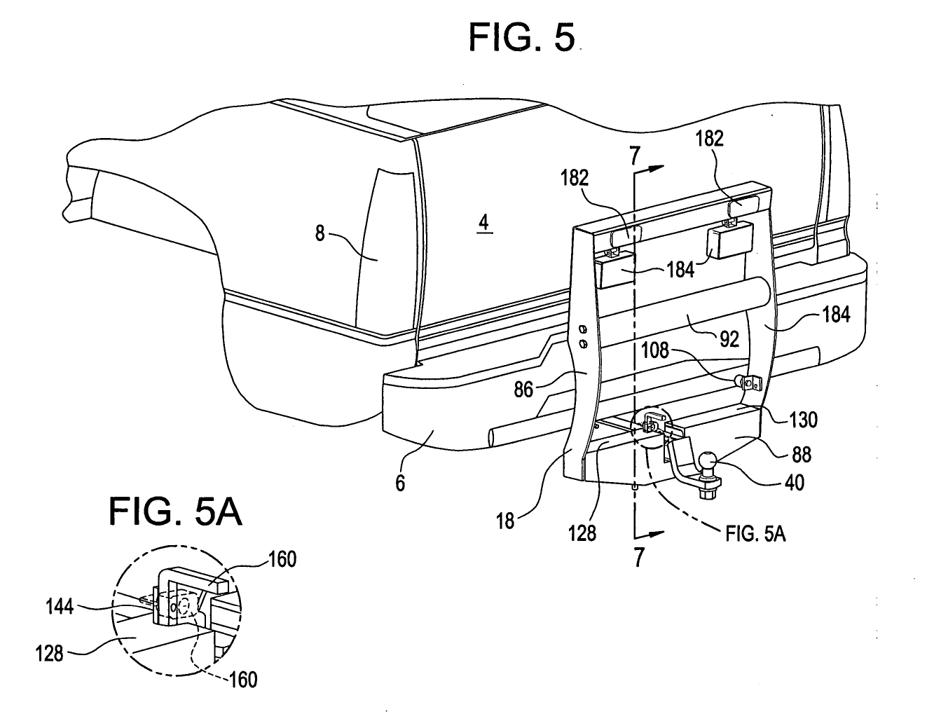

As shown in FIGS. 4a and 5, with the step 18 in the upright position, the lock aperture 146 of the latch guide 144 is aligned with the lock aperture 162 of the latch 160. A lock, such as a padlock, can be mounted through the lock apertures 146, 162 to secure the step 18 in the upright position. With the step 18 secured in the upright position, additional security is provided to the cargo area 2 of the pick-up truck 12 as the step 18 will prevent the tailgate 4 of the vehiclel 2 from being lowered to its open position. In addition, protection is provided to the tailgate 4 or rear door of the vehicle 12 because the step assembly 10 will be impacted by an outside object before the tailgate 4 or rear door of the vehicle 12 is impacted.

With the step 18 in the upright position, the brake lights 182 are directed rearwardly. Upon illumination of the brake lights 8 of the vehicle 12, the brakes lights 182 of the step assembly 10 will also illuminate to provide additional visual warning to following drivers that the vehicle 12 is stopping. If the switch 188 is positioned in the second/intermediate position, when the vehicle 12 is placed in reverse, the step lights 184 will illuminate.

In addition, with the step 18 in the upright position, portions of the step 18 extend in the forward direction. As a result, the top panel 180, a portion of the step 18 is positioned above a portion of the bumper 6, i.e. a portion of the step 18 is positioned higher than and in front of the rear most portion of the bumper 6.

Finally, mounting of the step assembly 10 to the vehicle 12 does not prohibit access to the ball assembly 78. Rather the ball assembly 78 can be accessed and articles can be towed using the ball assembly 78 without the need to remove the step assembly 10.

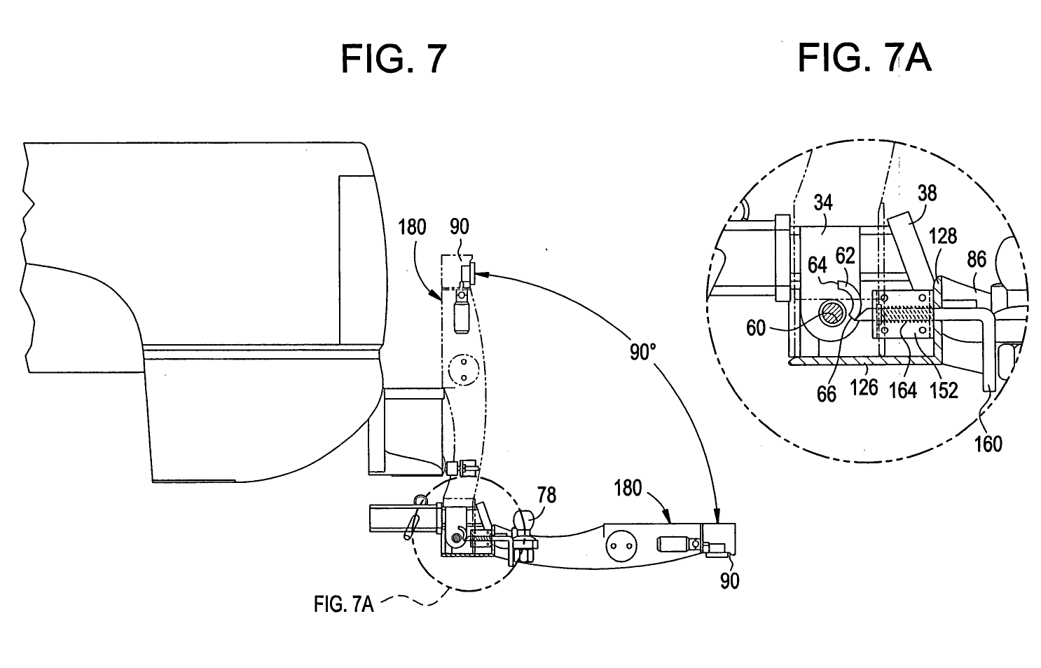

To lower the step assembly 10, the lock 63 is first removed from the latch guide 144 and the latch 160, the user grasps the first portion 160a of the latch 160. The user can lower the step 18 using one hand by pulling the latch 160 upward. As the latch 160 is pulled upward, the spring abutment 165 compresses the spring 164, until the tip 170 of the second portion 160b of the latch 160 contacts the outer surface of the flange 62. The user then releases latch 160 and rotates the step 18 away from the vehicle 12. The step 18 is rotated about the pin 194. The tip 170 of the latch 160 slides along the outer surface of the flange 62 until the tip 170 reaches the second end 66 of the flange 62, as shown in FIG. 7a. The step 18 will rotate approximately ninety degrees to reach the lowered position as shown in FIG. 7.

With the step 18 in the lowered position, the stepping member 180 of the rear member 90 extends horizontally and rearwardly beyond the lowered tailgate 4 of the vehicle 12. The stepping member 180 provides a surface preferably approximately twenty-seven inches wide by twelve inches deep. The user can step on the stepping member 180 to assist in loading items into the bed or cargo area 2 of the vehicle 12. Preferably, the height of the stepping member 180 of the step 18 is approximately one-half of the height from the ground to the bed or cargo area 2 of the vehicle 12 or approximately sixteen and one-half inches from the ground.

With the step 18 in the lowered position, the user can activate the switch 188 and the step lights 184 will illuminate the ground in the area surrounding the step 18 to provide greater visibility to the step 18 and the surrounding area. In addition, the swivel mounts 186 allow the user to position the lights 184 and direct the lights 184 as desired.

To raise the step 18 to the upright position, the user can simply grasp the rear member 90 and rotate the step 18 about the pin 194. As the user rotates the step 18, the tip 170 of the latch 160 slides along the outer surface of the flange 62 until the tip 170 reaches the second end 66 of the flange 62. The beveled surface 166 of the latch 160 allows the tip 170 to easily slide along the flange 62. The user continues to rotate the step 18. Upon rotating the step 18 ninety degrees, when the tip 170 passes the first end 64 of the flange 62, the spring pushes against the spring abutment 165 to force the latch 160 downward, such that the flat surface 168 of the latch 160 will engage the first end 64 of the flange 62 to secure the step 18 in the upright position as shown in FIG. 6a.

Mounting of the left and right side plates 34, 36 has been described such that the pivot pin apertures 60, 72 extend below the bottom wall 48 of the shaft 32. Alternatively, the left and right side plates 34, 36 could be mounted such that the pivot pin apertures 60, 72 extend above the top wall 46 of the shaft 32 when mounting the left and right side plates 34, 36 in this manner, assembly of the step assembly 10 results in the pin 194 positioned above the shaft 32.

Although the step assembly 10 is shown with a ball assembly 40 which can receive a trailer hitch, the step assembly 10 does not require the ball assembly 40.

Attention is now invited to a second embodiment of the step assembly 200 shown in FIGS. 9-14. The step assembly 200, is mounted to the rear of a vehicle, such as the vehicle 12 shown in FIG. 1. As with the step assembly 10, the step assembly 200 is mounted to the vehicle 12 using a conventional trailer hitch receiver 14 mounted to the frame of the vehicle 12.

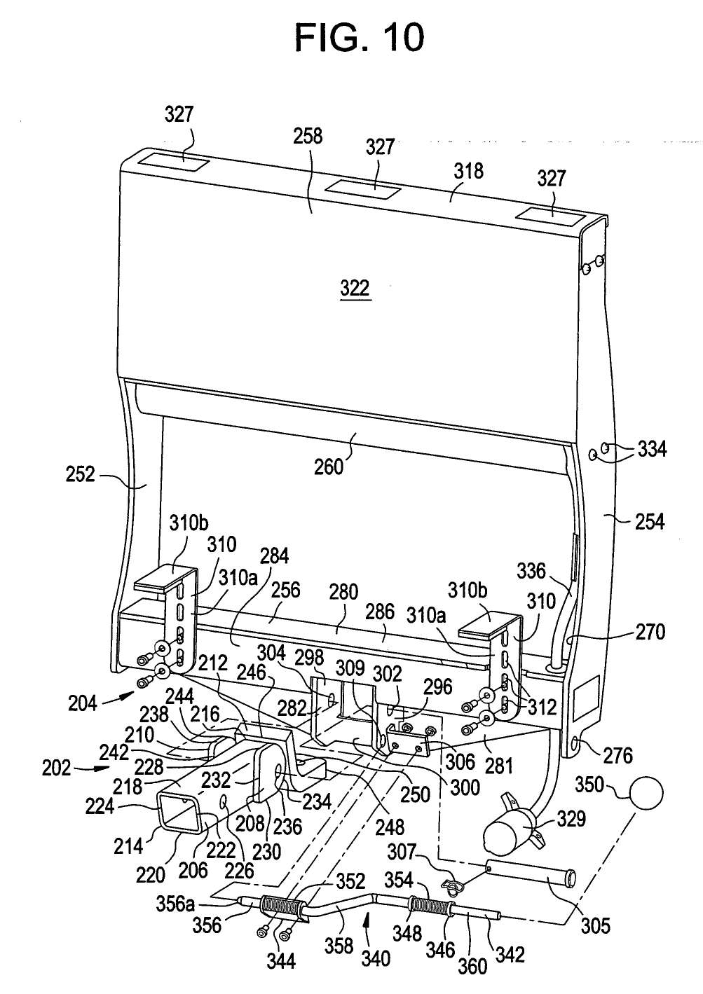

As shown in FIG. 10, the step assembly 200 generally includes a mounting member 202, to be slidably engaged with the trailer hitch receiver 14 and a step 204 which is pivotally mounted to the mounting member 202.

The mounting member 202 includes a shaft 206, a left side plate 208, a right side plate 210 and a brace 212.

The shaft 206 is generally tubularly-shaped, has a rectangular cross-section and has a front end 214 and a rear end 216. The shaft 206 includes a top wall 218, a bottom wall 220, a left wall 222 and a right wall 224. The height of the shaft 206 is slightly smaller than the height of the receiver passageway 28 of the trailer hitch receiver 14 and the width of the shaft 206 is slightly smaller than the width of the receiver passageway 28. Aligned mounting pin apertures 226 are provided through the left and right walls 222, 224. Aligned pivot pin apertures are provided through the left and right walls 22, 224, rearwardly of the mounting pin apertures 226.

The left side plate 208 includes a top edge 228, a bottom edge 230, a front edge 232 and a rear edge 234. The top edge 228 of the left side plate 208 is generally parallel to and aligned with the top wall 218 of the shaft 206 and is positioned above the top wall 218. The bottom edge 230 of the left side plate 208 is generally parallel to the bottom wall 220 of the shaft 206. The front edge 232 extends between the top edge 228 and the bottom edge 230 and is perpendicular thereto. The rear edge 234 is arc shaped and extends from the top edge 228 to the bottom edge 230 opposite the front edge 232. A pivot pin aperture 236 is provided through the left side plate 208.

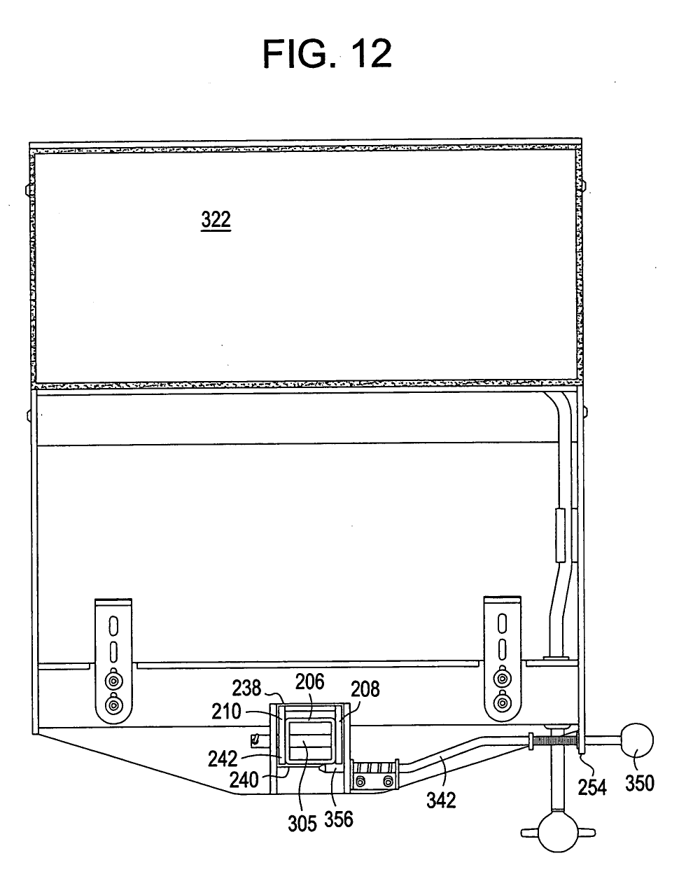

The right side plate 210 is identical to the left side plate 208. The right side plate 210 includes a top edge 238, a bottom edge 240 (FIG. 12), a front edge 242 and a rear edge 244. An pivot pin aperture is provided through the right side plate 210. The pivot pin aperture 236 of the left side plate 208 is aligned with the pivot pin aperture of the right side plate 210. The pivot pin apertures of the left and right side plate 210, 208, are aligned with the pivot pin apertures of the shaft 206.

The brace 212 is generally L-shaped and includes a front portion 246 and a rear portion 248. The front portion 246 of the brace 212 is fixed to the rear end 216 of the shaft 206. The rear portion 248 extend perpendicularly outwardly from the front portion 246. A ball aperture 250 is provided through the rear end portion 248.

The step 204 is generally rectangularly-shaped and includes a right support 252, a left support 254, a front member 256, a rear member 258 and a cross tube 260. The step 204 can be made from a variety of materials, such as, for example, tubular stainless steel, tubular painted steel, steel plate or plastic materials.

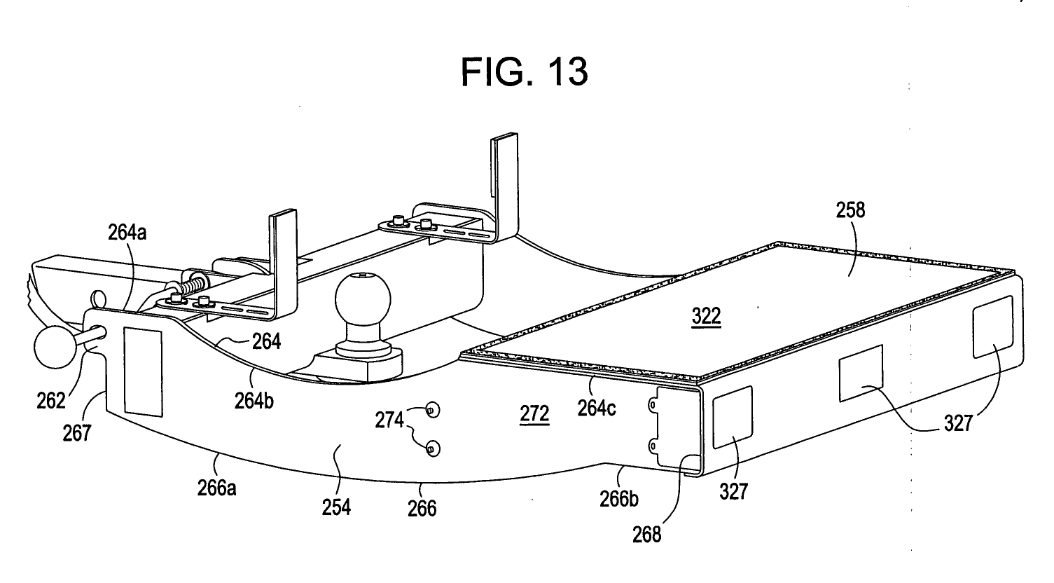

As best shown in FIG. 13, the left support 254 is elongated and includes a forwardly extending protrusion 262. The left support also includes a top edge 264, a bottom edge 266, a front edge 267, a rear edge 268, an interior side 270 (See FIG. 10) and an exterior side 272. The top edge 264 includes a first portion 264a, a second portion 264b, and a third portion 264c. The first portion 264a extends from the forwardly extending protrusion 262; the second portion 264b is curved and extends from the first portion 264a to the third portion 264c; the third portion 264c extends from the second portion 264b to the rear edge 264. The bottom edge 266 includes a first portion 266a and a second portion 266b. The first portion 266a is curved, extends from the front edge 267 of the left support 254 and is generally parallel to the second portion 264b of the top edge 264. The second portion 266b extends from the first portion 266a to the rear edge 268 of the left support 254, and is generally parallel to the third portion 264c of the top edge 264. Brace mounting apertures 274, which are spaced from the front edge 267 and the rear edge 268, are provided through the left support 254. A release handle aperture 276, shown in FIG. 13 is provided through the forwardly extending protrusion 262.

The right support 252 is identical to the left support 254 with the exception that the right support does not include a forwardly extending protrusion 262. Thus, the first portion of the top edge of the right support 252 extends from the front edge of the right support 252 rather than from a forwardly extending protrusion.

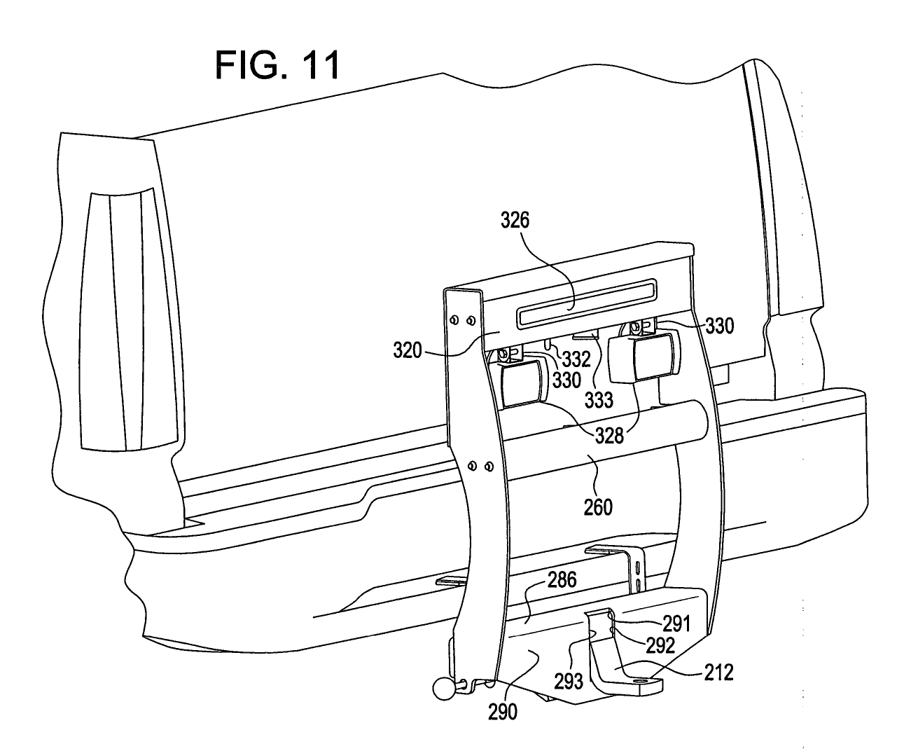

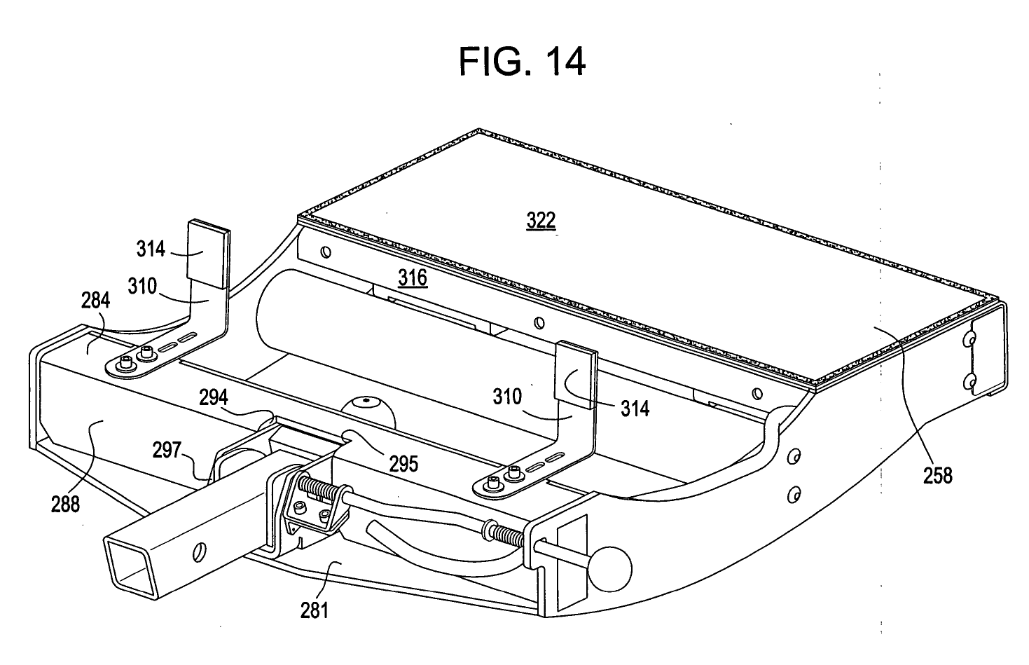

As shown in FIG. 10, the front member 256 includes an elongated generally rectangularly-shaped body 280, a triangularly-shaped extension 281 and a shaft brace 282. The body 280 extends between the right support 252 and the left support 254 proximate the front ends thereof. The body 280 includes a top panel 284, a rear panel 286, a front panel 288, see FIG. 14, and a bottom panel 290, see FIG. 11. The top panel 284 and the bottom panel 290 are generally parallel to each other, and the rear panel 286 and the front panel 288 are generally perpendicular to the top panel 284 and the bottom panel 290. The generally triangularly-shaped extension 281 is co-planar with the bottom panel 290 and extends form the bottom panel 290.

As best shown in FIG. 11, a centrally positioned notch 291 is provided in the rear panel 286 and a centrally positioned notch 293 is provided in the bottom panel 290. The notch 291 in the rear panel 286 communicates with the notch 293 in the bottom panel 290 to form a brace aperture 292. As best shown in FIG. 14, a centrally positioned notch 295 is provided in the top panel 284 and a centrally positioned notch 297 is provided in the front panel 288. The notch in the top panel 284 communicates with the notch in the front panel 288 to form a shaft aperture 294.

The shaft brace 282 is positioned within the shaft aperture 294 of the front member 256 and fixed thereto, for example, by welding. The shaft brace 282 is generally U-shaped and includes a left arm 296, a right arm 298 and a bottom member 300. The left arm 296 and the right arm 298 are generally parallel to each other and the bottom member 300 is generally perpendicular to the left and right arms 296, 298.

A pivot pin aperture 302 is provided through the left arm 296 and a pivot pin aperture 304 is provided through the right arm 298. The pivot pin aperture 302 is aligned with the pivot pin aperture 304. A pivot pin 305 extends through the pivot pin apertures 302, 304 and is secured in place with a locking pin 307 as will be described herein. A release handle aperture 309 is also provided through the left arm 296 of the shaft brace 282. A release handle support member 306 is affixed to the exterior surface of the left arm 296 of the shaft brace 282.

Two L-shaped anti-rack bumpers 310 are mounted to the top panel 284 of the front member 256. Each anti-rack bumper includes a first portion 310a and a second portion 310b extending perpendicularly from the first portion 310a. The anti-rack bumpers 310 are spaced approximately equidistance from the shaft aperture 294. The anti-rack bumpers 310 extend rearwardly and upwardly from the top panel 284 of the front member 256. Several mounting apertures 312 are provided through the first portion 310a of each anti-rack bumper 310 to provided adjustment of the anti-rack bumpers 310. By mounting the anti-rack bumpers 310 to the front member 256 using the apertures 312 proximate the free ends of the first portions 310a the second portions 310b are moved closer to the bumper of the vehicle. By mounting the anti-rack bumpers 310 to the front member 256 using the apertures 312 furthers from the free ends of the first portions 310a, the second portions 310b are moved away from the bumper of the vehicle. Pads 314, see FIG. 14, are provided on the free ends of the second portions 310b of the anti-rack bumpers 310.

The rear member 258 extends from the left support 254 to the right support 252, proximate the rear edges thereof. The rear member 258 includes a front panel 316 (see FIG. 14), a rear panel 318, a bottom panel 320 (see FIG. 11) and a stepping member 322. The front panel 316 is rectangularly-shaped and is spaced from the rear edges of the left and right supports 254, 252. The bottom panel 320 is rectangularly-shaped and extends from the left support 254 to the right support 252 proximate the bottom edges thereof and from the front panel 316 to the rear panel 318. The bottom panel 320 is perpendicular to the front and rear panels 316, 318. The rear panel 318 is rectangularly-shaped and extends from the left support 254 to the right support 252, proximate the rear edges thereof, and extends from the bottom panel 320 to the stepping member 322. The rear panel 318 is perpendicular to the bottom panel 320. Reflectors 327 are provided on the rear panel 318. The stepping member 322 is generally rectangular and extends from the left support 254 to the right support 252, and forward from the rear panel 318 along the third portions 264c of the top edges 264 of the left and right supports 252, 254. A tread is provided on the upper surface of the stepping member 322 to provide a skid resistant surface. The tread or skid resistant surface can be created, for example, by pouched metal, raised diamond plate, bonded rubber treads, spray on material or other skid resistant surfaces.

As best shown in FIG. 11, provided through the bottom panel 320 of the rear member 258 and an elongated brake light 326 is mounted through an aperture. The brake light 326 is connected to electronic circuitry such that when the brake lights 8 (see FIG. 1) of the vehicle 12 are illuminated, the brake light 326 is also illuminated.

Step lights 328 are mounted through swivel bases 330 to the front panel 316 of the rear member 258. The step lights 328 are spaced apart from each other such that each is proximate an end of bottom panel 320. The step lights 328 are electrically connected to a connector which is typically used to provide electrical power to a trailer, for example. The step lights 328 can be electrically connected to operate in conjunction with the vehicle's reverse lights. A switch 332 is also provided to supply power to the lights upon activation of the switch 332 when the step 200 is in use. The switch 322 can be, for example, a three way switch similar to the switch 188 described in connection with the first embodiment of the invention. Electrical connections to the brake light 326 and the step lights 328 is provided by wires housed in a conduit 336, see FIG. 10. A connector provides electrical connection to the electronic circuitry of the vehicle 12. A power outlet 333 is provided for attachment of a variety of accessories such as, for example, an air compressor, a spotlight, a cooler or a battery charger. The power outlet 333 is preferably a 12 volt power outlet.

The cross tube 260 is cylindrically-shaped and extends from the left support 254 to the right support 252. The cross tube 260 is spaced from the rear edges of the left support 254 and the right support 252 and is fixed to the left and right supports 254, 252 by passing fasteners, such as, for example, bolts 334 through the apertures in the left and right supports 254, 252 and securing the bolts 334 to the cross tube 260. The cross tube 260 could also be welded to the left and right supports 254, 252.

As best shown in FIG. 10, a release handle assembly 340 includes an elongated handle 342, a mounting bracket 344, a left spring bumper 346, a right spring bumper 348, a gripping ball 350, a first spring 352 and a second spring 354.

The handle 342 includes a first portion 356, a second portion 358 and a third portion 360. The first portion 356 of the handle 342 includes a tapered tip 356a. The second portion 358 of the handle 342 extends from the end of the first portion 356 opposite the tip 356a and is angled relative to the first portion 356. The third portion 360 of the handle 342 extends from the end of the second portion 358 opposite the first portion 356 and is angled relative to the second portion 358. The first portion 356 is generally parallel to the third portion 360.

The mounting bracket 344 is positioned around the first portion 356 of the handle 342.

The first spring 352 is also positioned around the first portion 356 of the handle 342 and is positioned within the mounting bracket 344. A spring abutment is fixed to the first portion 356 of the handle 342 proximate the first spring 352 to compress the first spring 352 as will be described herein.

The left spring bumper 346 and the right spring bumper 348 are positioned around the third portion 360 of the handle 342. The right spring bumper 348 is fixed to the third portion 360 of the handle 342, while the left spring bumper 346 moves relative to the third portion 360 of the handle 342. The second spring 354 is also positioned around the third portion 360 of the handle 342 and is positioned between the left spring bumper 346 and the right spring bumper 348.

The gripping ball 350 is mounted on the outer end of the third portion 360 of the handle 342.

The mounting bracket 344 is mounted to the release handle support member 306 of the shaft brace 82 using, for example, bolts and nuts. The release handle assembly 340 is aligned with the remainder of the step 204 such that the handle 342 passes through the release handle aperture 309 of the left arm 296 of the shaft brace 282 and through the release handle aperture 276 of the left support 254.

Now that the specifics of the components of the step assembly 200 have been described, assembly of the step assembly 200 is described. Assembly of the step assembly 200 begins by placing the shaft 206 of the mounting member 202 into the passageway 28 of the trailer hitch receiver 14 and aligning the apertures 226 of the shaft 202 with the apertures 30 of the trailer hitch receiver 14. A pin is passed through the apertures 226, 30 to secure the shaft 206 within the trailer hitch receiver 14. Next, the step 204 is aligned with the mounting member 202 such that the left side plate 208 of the mounting member 202 is positioned proximate the left arm 296 of the shaft brace 282 and the right side plate 210 of the mounting member 202 is positioned proximate the right arm 298 of the shaft brace 282. When the step 204 is properly aligned with the mounting member 202, the pivot pin aperture 302 of the shaft brace 282 is aligned with the pivot pin aperture 236 of the left side plate 208 and the pivot pin aperture 304 of the shaft brace 282 is aligned with the pivot pin aperture of the right side plate 210. The pivot pin 305 is then inserted through the aperture 302 of the left arm 296 of the shaft brace 282, through the aperture 236 of the left side plate 208 of the mounting member 202, through the aperture of the right side plate 210 of the mounting member 202, and through the right arm 298 of the shaft brace 282. The retaining pin 307 is then inserted through the retaining pin aperture of the retaining pin 305 to secure the retaining pin 307.

As best shown in FIGS. 9 and 12, when the step 204 is in the upright position, the first portion 356 of the release handle 342 is positioned under the shaft 206 of the mounting member 202 and under the left plate 208 of the mounting member 202. The gripping ball 350 extends to the left of the left support 254. Contact between the handle 342, the shaft 206 and the left plate 208, prevents rotation of the step 204 about the pivot pin 305. Similar to the step 18, when the step 204 is in the upright position, the stepping member 322 of the rear member 258 is positioned above the bumper 6 of the vehicle 12 and the bumper 6 is positioned within the curvature of the second portions 264b of the top edges 264 of the left and right supports 254, 252. The curvature of the second portions 254b allows the stepping member 322 to be positioned closer to the tailgate 4 of the vehicle 12 by utilizing the space above the bumper 6 of the vehicle 12 when the step 204 is in the upright position. Thus, the stepping member 322 is positioned forward of at least a portion of the bumper 6. The anti-racking bumpers 310 contact the bumper 6 of the vehicle and serve to dampen road vibrations and to remove any play between the step assembly 200 and the vehicle 12.

With the step 204, protection is provided to the tailgate 4 or rear door of the vehicle 12 because the step assembly 200 will be impacted by an outside object before the tailgate 4 or rear door of the vehicle 12 is impacted. Also with the step 204 in the upright position, the brake light 326 is directed rearwardly. Upon illumination of the brake lights 8 of the vehicle 12, the brakes light 326 of the step assembly 10 will also illuminate to provided additional visual warning to following drivers that the vehicle 12 is stopping.

Finally, with the step 204 in the upright position, a ball assembly mounted within the brace 212 can be accessed and articles can be towed using the ball assembly without the need to remove the step assembly 204.

To lower the step assembly 204, the user grasps the gripping ball 350 and pulls, the gripping ball 350 along with the handle 342 outwardly (i.e. to the left). As the user pulls the gripping ball 350, the spring abutment proximate the first spring 344 will cause the first spring 344 to compress and the right spring bumper 348 will cause the second spring 346 of the release handle assembly 340 to compress. As the springs 344, 346 compress and the tip 356 of the handle 342 will move to the left of the shaft 206 and the left side plate 208 of the mounting member 202. Once the tip 356a has cleared the left side plate 208 of the mounting member 202, the step 204 is free to rotate about the pivot pin 305. The step 204 continues to rotate ninety (90) degrees until the step 204 reaches the lowered position as shown in FIGS. 13 and 14. In the lowered position, the handle 342 is held outwardly, the first and second springs 344, 346 are compressed, and the tip 356a of the handle 342 contacts the outer surface of the left side plate 208. Rotation of the step 204 beyond ninety degrees is prevented through contact of the bottom member 300 of the shaft brace 282 and the bottom surface of the shaft 306 and the bottom edges of the left and right side plates 208, 210.

Rotation of the step 204 beyond ninety degrees is also prevented through contact of the brace 212 and the front member 256.

With the step 204 in the lowered position, the stepping member 322 of the rear member 258 extends horizontally and rearwardly beyond the lowered tailgate 4 of the vehicle 12. The stepping member 322 provides a surface preferably approximately twenty-seven inches wide by twelve inches deep. The user can step on the stepping member 322 to assist in loading items into the bed 2 of the pick-up truck 12.

Preferably, the height of the stepping member 322 of the step 204 is approximately one-half of the height from the ground to the bed or cargo area 2 of the vehicle 12 or approximately sixteen and one-half inches from the ground.

With the step 204 in the lowered position, the user can activate the switch 332 and the step lights 328 will illuminate the ground in the area surrounding the step 204 to provide greater visibility to the step 204 and the surrounding area. In addition, the swivel mounts 330 allow the user to position the lights 328 and direct the lights 328 as desired.

To raise the step 204 to the upright position, the user simply grasps the rear member 258 and rotates the step 204 about the pivot pin 305. As the user rotates the step 204, the tip 356a of the handle 342 slides along the outer surface of the left side plate 208. The user continues to rotate the step 204 until the tip 356a reaches the bottom edge 230 of the left side plate 208. Upon rotating the step 204 ninety degrees, spring 346 expands, thereby pushing against the right spring bumper 348 to force the handle 342 inwardly. The first portion 356 of the handle 342 will extend under the left side plate 308 and under the shaft 306 of the mounting member 302 to secure the step 304 in the upright position.

Unlike the step assembly 10 described above which provides rotation of the step about the pin 194 which can be positioned either above or below the shaft 32, the step assembly 200 provides rotation of the step about the pin 305 which is centrally positioned within the shaft 206. The step assembly 200 allows pivoting of the step to occur in an area of low stress. In addition, the longer left and right side plates 34, 36 are not necessary, therefore, the step assembly 200 is more compact.

Attention is now invited to the third embodiment of the step assembly 400 shown in FIGS. 15 and 16.

The step assembly 400 is identical to the second embodiment of the step assembly 200, however, the step assembly 400 includes additional features. The step assembly 400 is preferably used in connection with recreational vehicles (RVs). As shown in FIG. 15, the step assembly 400 includes a generally rectangularly-shaped step cover 402. The step cover 402 includes a stepping surface 404 and a skirt 406 depending from the left, right and rear sides of the stepping surface 404. Mounting apertures 408 are provided proximate the front side of the stepping surface 404. Mounting apertures 410 are provided in the portion of the skirt 406 depending from the rear side of the stepping surface 404. To mount the step cover 402 to the remainder of the step assembly 400, the portion of the stepping surface 404 including the mounting apertures 408 is placed over the front member 256 of the step assembly and fasteners 412 are passed through the apertures 408 and through apertures 414 the front member 256 to secure the step cover 402 to the front member 256. The mounting apertures 410 in the skirt 406 are then aligned with apertures provided through the rear member 258 and fasteners are passed through the apertures 410 to secure the step cover 404 to the rear member 258.

As shown in FIG. 16, a license plate bracket 412 is provided on the bottom surface of the step cover 402 for mounting a license plate thereto. Optional anti-rack bumpers 414 are provided to engage the bumper to the vehicle. The anti-rack bumpers dampen road vibrations and remove any play between the step assembly 400 and the vehicle.

The step cover 402 provides additional surface on which a user can step when entering an RV.

Attention is now invited to a fourth embodiment of the invention shown in FIG. 17. The step assembly 500 includes a step cover 502 with a stepping surface 504 and is identical to the step assembly 400 of the invention with the following exceptions described below.

The step cover 502 includes hinges 503, a stepping surface 504, a flange 506, tabs 508, and a latch 510.

Unlike the step cover 402 which is fixedly mounted to the remainder of the step assembly 400, the step 502 is hingedly mounted to the rear member 258 through the hinges 503. More specifically, first portions of hinges are mounted to the front panel 316 of the rear member 258 and second portions of hinges are mounted to the step cover 502. Pivot pins are provided to engage the first portions of the hinges with the second portions of the hinges. The hinges 503 allow the step cover 502 to rotate 180 degrees from a first/open position to a second/folded position.

The flange 506 extends from the stepping surface 504 and is perpendicular thereto. The tabs 508 also extend from the stepping surface 504 and are essentially co-planar with the stepping surface 504. The latch 510 is provided on the flange 506 and is positioned between the tabs 508.

In the first/open position, the step cover 502 is positioned proximate the rear member 258 such that the stepping surface 322 of the rear member 258 and the stepping surface 504 of the step cover 502 are co-planar. In the first/open position, the tabs 508 engage the front member 256 to provide further support to the step cover 502. In the second/folded position, the step cover 502 is positioned above the rear member 258 such that the stepping surface 504 rests upon the stepping surface 322.

In the second/folded position the flange 506 extends over the rear panel 318 of the rear member 258. A latch 512 can be provided on the rear panel 318 of the rear member 258 to engage the latch 510 on the step cover 502. The interengaged latches 510, 512 secure the step cover 502 in the folded position.

As with the step cover 402 of the step assembly 400, the step cover 502 of the step assembly 500 provides additional surface on which a user can step when entering the vehicle. The step cover 502 can, however, be rotated to the second/folded position when the step assembly 500 is not in use. In this second/folded position, the step cover 502 is generally aligned with the stepping surface 322 of the rear member 258. Therefore, the step cover 502 is not positioned to the rear of the license plate and it is not necessary to relocate the license plate of the vehicle. Rather, the license plate can be mounted to the rear of the vehicle in the typical manner. When the step cover 502 is rotated to the folded position the license plate can be viewed without obstruction.

While preferred embodiments of the present invention are shown and described, it is envisioned that those skilled in the art may devise various modifications of the present invention without departing from spirit and scope of appended claims.

The invention claimed is:

1. A step assembly for attachment to a trailer hitch receiver of a vehicle including a bumper, the step assembly comprising:
a mounting member for engagement with the trailer hitch receiver,
a step pivotally attached to said mounting member, said step including a stepping member, wherein said stepping member is placed in a generally vertical position when said step is not in use and is positioned higher than the bumper of the vehicle, and wherein said stepping member is placed in generally horizontal position when said step is in use.

2. A step assembly as defined in claim 1, wherein when said step assembly is used with a vehicle including a tail gate, at least a portion of said stepping member of said step extends beyond the tail gate of the vehicle when the tail gate is in a lowered position.

3. A step assembly as defined in claim 1, wherein when said step assembly is not in use, at least a portion of said stepping member extends above at least a portion of the bumper of the vehicle.

4. A step assembly as defined in claim 1, further including a brake light provided on said step in communication with a brake light of the vehicle.

5. A step assembly as defined in claim 1, further including a step light provided on said step and means for activating said step light.

6. A step assembly as defined in claim 5, wherein said step light is mounted on said step by a swivel bracket.

7. A step assembly as defined in claim 1, said step further includes a latch and said mounting member further includes a flange for cooperating with said latch, wherein said latch and said flange cooperate to secure said step in the generally horizontal position and in the generally vertical position.

8. A step assembly as defined in claim 7, further including a lock for securing said step in said generally vertical position.

9. A step assembly as defined in claim 7, wherein said flange is crescent-shaped.

10. A step assembly as defined in claim 1, further including a release handle assembly mounted to said step, wherein said release handle assembly includes a release handle, a portion of which abuts said mounting member to secure said step member in said generally vertical position and wherein said release handle is positioned proximate said mounting member as said step is pivoted from said generally vertical position to said generally horizontal position.

11. A step assembly as defined in claim 10, wherein said release handle assembly further includes a spring, and wherein said spring urges said release handle toward said mounting member.

12. A step assembly as defined in claim 1, said step further including at least one anti-rack bumper.

13. A step assembly as defined in claim 1, said step further including a shaft brace which mates with said mounting member and wherein said shaft brace abuts said mounting member to prevent rotation of said step beyond said generally horizontal position.

14. A step assembly as defined in claim 1 wherein said step includes a brace, said brace supporting a ball assembly.

15. A step assembly as defined in claim 1, further including a step cover mounted to said step.

16. A step assembly as defined in claim 15, wherein said step cover is pivotally mounted to said step and said step cover can be aligned with said stepping member when said stepping member is placed in a generally vertical position.

17. A step assembly for attachment to a trailer hitch receiver of a vehicle including a bumper, the step assembly comprising:
a mounting member including a shaft for engagement with the trailer hitch receiver,
a pivoting axis mounted to said mounting member;
a step pivotally attached to said pivoting axis, said step including a stepping member;
wherein when said step is not in use, said stepping member is pivoted to a generally vertical position and at least a portion of said stepping member is positioned over at least a portion of the bumper, and
wherein said step is in use, said stepping member is pivoted to a generally horizontal position.

18. A step assembly as defined in claim 17, wherein said pivoting axis is mounted above the shaft of said mounting member.

19. A step assembly as defined in claim 17, wherein said pivoting axis is mounted below the shaft of said mounting member.

20. A step assembly as defined in claim 17, said mounting member further
including a flange, said step further including a latch for engagement with said flange, and
wherein when said step is not in use, said latch abuts said flange to secure said stepping member in a generally vertical position and said latch moves along a surface of said flange when said stepping member is pivoted to a generally horizontal position when said step is in use.

21. A step assembly for attachment to a trailer hitch receiver of a vehicle including a bumper, the step assembly comprising:
a mounting member including a shaft for engagement with the trailer hitch receiver;
a step including a stepping member;
a pivoting axis extending through said shaft of said mounting member for providing pivotal engagement between said mounting member and said step;
wherein when said step is not in use, said stepping member in a generally vertical position and at least a portion of said stepping member is positioned above at least a portion of the bumper of the vehicle; and
wherein when said step is in use, said stepping member is in a generally horizontal position.

22. A step assembly as defined in claim 21, further including:
a release handle assembly including a release handle moveably attached to said mounting member;
wherein when said step is not in use, said release handle abuts said mounting member to secure said stepping member in a generally vertical position; and
wherein as said stepping member is pivoted from a generally vertical position to a generally horizontal position, said release handle is positioned proximate said shaft of said mounting member.

23. A step assembly as defined in claim 21, further including a step cover mounted to said step.

24. A step assembly as defined in claim 23, wherein said step cover is pivotally mounted to said step and said step cover can be aligned with said stepping member when said stepping member is placed in a generally vertical position

25. A step assembly as defined in claim 21, wherein said mounting member further include a ball assembly.
